(19) United States
(12) Patent Application Publication
(10) Pub. No.: US 2024/0397914 A1
(43) Pub. Date: Dec. 5, 2024

(54) SYSTEMS, DEVICES, AND METHODS FOR DETERMINING A CHANGE IN A CHARACTERISTIC OF A PET

(71) Applicant: Mars, Incorporated, McLean, VA (US)

(72) Inventors: Russ SMITH, San Francisco, CA (US); Okhtay AZARMANESH, San Francisco, CA (US)

(21) Appl. No.: 18/679,727

(22) Filed: May 31, 2024

Related U.S. Application Data
(60) Provisional application No. 63/505,777, filed on Jun. 2, 2023.

(51) Int. Cl. A01K 29/00

(52) U.S. Cl. CPC A01K 29/005

(57) ABSTRACT

Methods and systems for determining a change in a characteristic of a pet are provided. An example method includes: receiving, by one or more processors, sensor data generated by one or more pressure sensors integrated within a mat based on the pet moving over the mat; determining, by the one or more processors, a representation of the characteristic of the pet using an artificial intelligence (AI) model and the sensor data; determining, by the one or more processors, the change in the characteristic of the pet based on the representation of the characteristic of the pet and a baseline representation of the characteristic of the pet; generating, by the one or more processors, a notification including information identifying the change in the characteristic of the pet; and providing, by the one or more processors, the notification to a user device to cause the user device to display the notification.

### CROSS-REFERENCE TO RELATED APPLICATION(S)

This application claims the benefit of priority to U.S. Provisional Application No. 63/505,777, filed on Jun. 2, 2023, the entirety of which is incorporated herein by reference.

### TECHNICAL FIELD

The present disclosure relates generally to systems, devices, and methods for determining a change in a characteristic of a pet. More specifically, aspects of the disclosure pertain to systems, devices, and methods for determining a change in a characteristic of a pet, such as weight and/or gait, using an artificial intelligence (AI) model and sensor data generated by one or more pressure sensors integrated within a mat based on the pet moving over the mat.

### BACKGROUND

A change in a characteristic (e.g., weight, gait, etc.) of a pet can be an important indicator of the pet's health. For example, a change in a characteristic of the pet can be indicative of an underlying need for medical attention. Accordingly, a pet owner should routinely monitor for a change in a characteristic of the pet.

As an example, the pet owner can attempt to visually ascertain weight and/or gait changes of the pet. However, some weight and/or gait changes can be visually imperceptible to the pet owner. In other cases, the pet owner can attempt to weigh the pet using conventional devices, such as a scale. However, doing so might require the pet to remain relatively stationary on the scale for a relatively long period of time. As such, the pet owner might not be capable of easily or frequently weighing the pet. Similarly, the pet owner can attempt to image the pet's gait in order to detect gait changes. However, doing so might require relatively elaborate dedicated imaging hardware that might be impractical to use on a routine basis.

Accordingly, there is a need for a technique for quickly, practically, easily, frequently, and accurately monitoring and determining changes in a characteristic of a pet. Moreover, there is a need for a technique for monitoring and determining changes in a characteristic of a pet that requires less dedicated hardware and that is less intrusive than other techniques.

### SUMMARY

According to one example aspect, a method for determining a change in a characteristic of a pet may include receiving, by one or more processors, sensor data generated by one or more pressure sensors integrated within a mat based on the pet moving over the mat; determining, by the one or more processors, a representation of the characteristic of the pet using an artificial intelligence (AI) model and the sensor data; determining, by the one or more processors, the change in the characteristic of the pet based on the representation of the characteristic of the pet and a baseline representation of the characteristic of the pet; generating, by the one or more processors, a notification including information identifying the change in the characteristic of the pet; and providing, by the one or more processors, the notification to a user device to cause the user device to display the notification.

According to another example aspect, a device for determining a change in a characteristic of a pet may include a memory configured to store instructions; and one or more processors configured to execute the instructions to perform operations comprising: receiving sensor data generated by one or more pressure sensors integrated within a mat based on the pet moving over the mat; determining a representation of the characteristic of the pet using an artificial intelligence (AI) model and the sensor data; determining the change in the characteristic of the pet based on the representation of the characteristic of the pet and a baseline representation of the characteristic of the pet; generating a notification including information identifying the change in the characteristic of the pet; and providing the notification to a user device to cause the user device to display the notification.

According to a further example aspect, a non-transitory computer-readable medium may store instructions that, when executed by one or more processors of a device for determining a change in a characteristic of a pet, cause the one or more processors to perform operations comprising: receiving sensor data generated by one or more pressure sensors integrated within a mat based on the pet moving over the mat; determining a representation of the characteristic of the pet using an artificial intelligence (AI) model and the sensor data; determining the change in the characteristic of the pet based on the representation of the characteristic of the pet and a baseline representation of the characteristic of the pet; generating a notification including information identifying the change in the characteristic of the pet; and providing the notification to a user device to cause the user device to display the notification.

It may be understood that both the foregoing general description and the following detailed description are exemplary and explanatory only and are not restrictive of the invention, as claimed.

### BRIEF DESCRIPTION OF THE DRAWINGS

FIG. 1 is a diagram of a system for determining a change in a characteristic of a pet.

FIG. 2 is a diagram of components of one or more devices of the system of FIG. 1.

FIG. 3 is a diagram of an example mat integrated with one or more pressure sensors for generating sensor data.

FIG. 4 is a diagram of a pet moving over the mat.

FIG. 5 is a diagram of example sensor data generated by the one or more pressure sensors of the mat.

FIG. 6 is a flowchart depicting an example process for determining a change in a characteristic of a pet using an AI model and the sensor data generated by the one or more pressure sensors of the mat.

FIG. 7 is a flowchart depicting an example process for training the AI model.

FIG. 8 is a diagram of an example user interface of a user device for displaying a notification including information identifying the change in the characteristic of the pet.

### DETAILED DESCRIPTION

The accompanying drawings, which are incorporated in and constitute a part of this specification, illustrate example embodiments of the present disclosure and together with the description, serve to explain the principles of the disclosure.

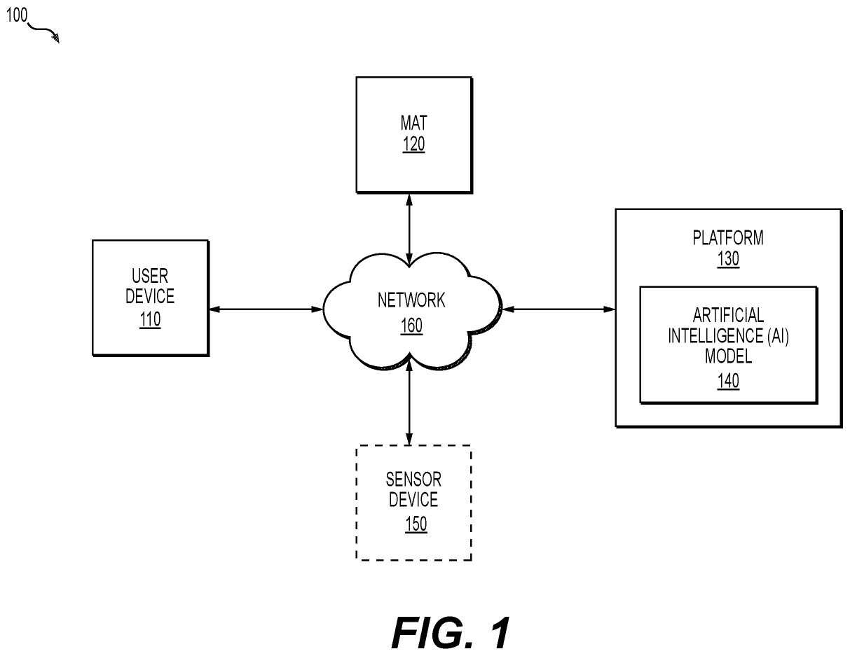

FIG. 1 is a diagram of a system 100 for determining a change in a characteristic of a pet. As shown in FIG. 1, the system 100 may include a user device 110, a mat 120, a platform 130, an AI model 140, a sensor device 150, and a network 160.

The user device 110 may include a device configured to display and/or audibly present information received from the platform 130 that identifies a change in a characteristic of a pet. For example, the user device 110 may be a smartphone, a desktop computer, a tablet computer, a laptop computer, a smart speaker, a wearable device, or the like. Additionally, in some aspects, the user device 110 may be used as an intermediary device configured to facilitate communication of data between the mat 120 and the platform 130.

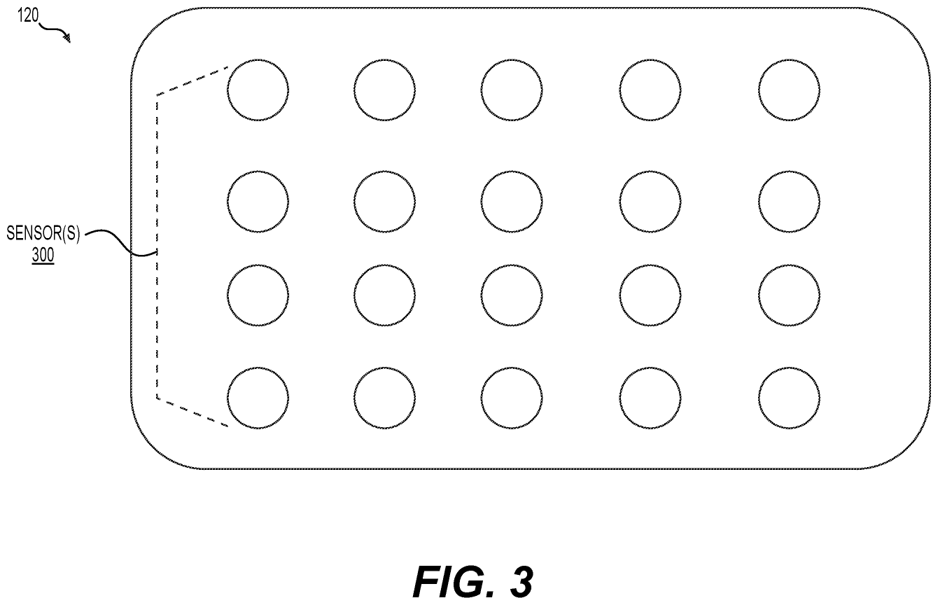

The mat 120 may include a device configured to generate sensor data based on a pet moving over the mat 120. For example, and as described in more detail with reference to FIG. 3, the mat 120 may include one or more pressure sensors for generating sensor data as the pet moves over the mat 120, where the mat 120 may be floor-based to permit the pet to move over the mat 120. The mat 120 may be positioned substantially anywhere inside or outside of an abode of an owner of the pet. For example, the mat 120 may be positioned in front of a door of an abode of the pet owner, adjacent to a feeding area of the pet, or any other suitable location where the pet is likely to move over the mat 120. Because the mat 120 is capable of being placed substantially anywhere in or outside of the abode, the mat 120 can more frequently generate sensor data based on the pet more frequently moving over the mat 120.

The mat 120 may include a microcontroller (MCU), a power supply, one or more pressure sensors, and a communication interface. The MCU may receive sensor data generated by the one or more pressure sensors, and provide the sensor data to the platform 130. For example, the MCU may directly provide the sensor data to the platform 130. Alternatively, the MCU may provide the sensor data to the platform 130 via one or more intermediary devices, such as the user device 110.

The platform 130 may be a device configured to perform operations comprising: receiving sensor data generated by one or more pressure sensors integrated within the mat 120 based on the pet moving over the mat 120; determining a representation of the characteristic of the pet using the AI model 140 and the sensor data; determining the change in the characteristic of the pet based on the representation of the characteristic of the pet and a baseline representation of the characteristic of the pet; generating a notification including information identifying the change in the characteristic of the pet; and providing the notification to the user device 110 to cause the user device 110 to display the notification. For example, the platform 130 may be a server, a cloud-computing device, or the like. The platform 130 may include and/or may be associated with one or more data storage systems.

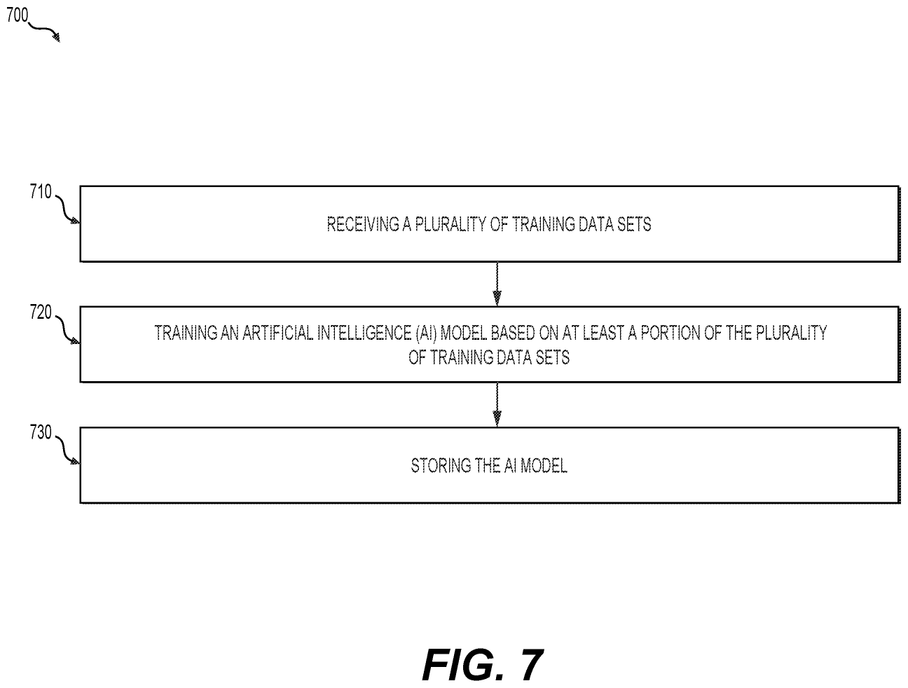

The AI model 140 may be a model configured to receive sensor data generated by the one or more pressure sensors of the mat 120, and determine a representation of the characteristic of the pet based on the sensor data. For example, the AI model 140 may be a neural network, a support vector machine, a Bayesian network, or the like. In some implementations, and as described in more detail in FIG. 7, the AI model 140 may be trained using a training technique and training data. The training data may include sensor data that is correlated with known representations of characteristics. The platform 130 may store the trained AI model 140 in one of the data storage systems of and/or associated with the platform 130, and use the trained AI model 140 to determine characteristics based on the sensor data. Additionally, or alternatively, the platform 130 (or another device) may provide the trained AI model 140 to the user device 110 to permit the user device 110 to use the trained AI model 140.

The sensor device 150 may be a device configured to obtain information associated with the pet. For example, the sensor device 150 may be a smart pet collar, a smart pet feeder, etc.

The network 160 may be a cellular network (e.g., a fifth generation (5G) network, a long-term evolution (LTE) network, a third generation (3G) network, a code division multiple access (CDMA) network, etc.), a public land mobile network (PLMN), a local area network (LAN), a wide area network (WAN), a metropolitan area network (MAN), a telephone network (e.g., the Public Switched Telephone Network (PSTN)), a private network, an ad hoc network, an intranet, the Internet, a fiber optic-based network, or the like, and/or a combination of these or other types of networks.

The number and arrangement of devices shown in FIG. 1 are provided as an example. In practice, there may be additional devices, fewer devices, different devices, or differently arranged devices than those shown in FIG. 1. Furthermore, two or more devices shown in FIG. 1 may be implemented within a single device, or a single device shown in FIG. 1 may be implemented as multiple, distributed devices. Additionally, or alternatively, a set of devices (e.g., one or more devices) of the system 100 may perform one or more functions described as being performed by another set of devices of the system 100.

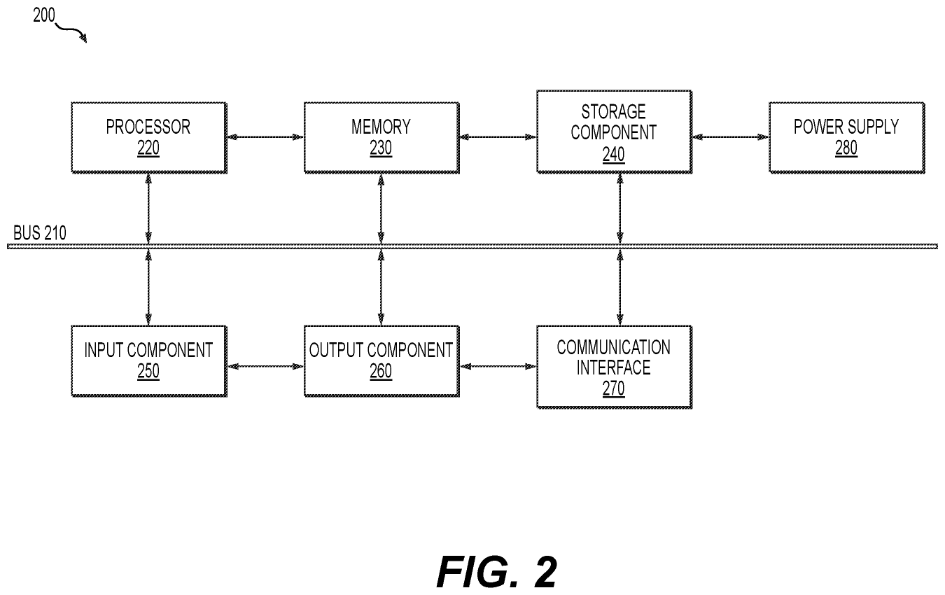

FIG. 2 is a diagram of components of one or more devices of the system 100 of FIG. 1. For example, the device 200 may correspond to the user device 110, the mat 120, the platform 130, and/or the sensor device 150.

As shown in FIG. 2, the device 200 may include a bus 210, a processor 220, a memory 230, a storage component 240, an input component 250, an output component 260, a communication interface 270, and a power supply 280.

The bus 210 includes a component that permits communication among the components of the device 200. The processor 220 may be implemented in hardware, firmware, or a combination of hardware and software. The processor 220 may be a central processing unit (CPU), a graphics processing unit (GPU), an accelerated processing unit (APU), a microprocessor, a microcontroller (MCU), a digital signal processor (DSP), a field-programmable gate array (FPGA), an application-specific integrated circuit (ASIC), or another type of processing component.

The processor 220 may include one or more processors capable of being programmed to perform a function. The memory 230 may include a random access memory (RAM), a read only memory (ROM), and/or another type of dynamic or static storage device (e.g., a flash memory, a magnetic memory, and/or an optical memory) that stores information and/or instructions for use by the processor 220.

The storage component 240 may store information and/or software related to the operation and use of the device 200. For example, the storage component 240 may include a hard disk (e.g., a magnetic disk, an optical disk, a magneto-optic disk, and/or a solid state disk), a compact disc (CD), a digital versatile disc (DVD), a floppy disk, a cartridge, a magnetic tape, and/or another type of non-transitory computer-readable medium, along with a corresponding drive.

The input component 250 may include a component that permits the device 200 to receive information, such as via user input (e.g., a touch screen display, a keyboard, a keypad, a mouse, a button, a switch, and/or a microphone for receiving the reference sound input). Additionally, or alternatively, the input component 250 may include a sensor for sensing information (e.g., a pressure sensor (e.g., a piezoelectric sensor), a global positioning system (GPS) component, an accelerometer, a gyroscope, and/or an actuator). The output component 260 may include a component that provides output information from the device 200 (e.g., a display, a speaker for outputting sound at the output sound level, and/or one or more light-emitting diodes (LEDs)).

The communication interface 270 may include a transceiver-like component (e.g., a transceiver and/or a separate receiver and transmitter) that enables the device 200 to communicate with other devices, such as via a wired connection, a wireless connection, or a combination of wired and wireless connections. The communication interface 270 may permit the device 200 to receive information from another device and/or provide information to another device. For example, the communication interface 270 may include an Ethernet interface, an optical interface, a coaxial interface, an infrared interface, a radio frequency (RF) interface, a universal serial bus (USB) interface, a Wi-Fi interface, a cellular network interface, or the like. The power supply 280 may be a device configured to provide power to the mat 120. For example, the power supply 280 may be a battery, an adapter, or the like.

The device 200 may perform one or more processes described herein. The device 200 may perform these processes based on the processor 220 executing software instructions stored by a non-transitory computer-readable medium, such as the memory 230 and/or the storage component 240. A computer-readable medium may be defined herein as a non-transitory memory device. A memory device may include memory space within a single physical storage device or memory space spread across multiple physical storage devices.

The software instructions may be read into the memory 230 and/or the storage component 240 from another computer-readable medium or from another device via the communication interface 270. When executed, the software instructions stored in the memory 230 and/or the storage component 240 may cause the processor 220 to perform one or more processes described herein. Additionally, or alternatively, hardwired circuitry may be used in place of or in combination with software instructions to perform one or more processes described herein. Thus, implementations described herein are not limited to any specific combination of hardware circuitry and software.

The number and arrangement of the components shown in FIG. 2 are provided as an example. In practice, the device 200 may include additional components, fewer components, different components, or differently arranged components than those shown in FIG. 2. Additionally, or alternatively, a set of components (e.g., one or more components) of the device 200 may perform one or more functions described as being performed by another set of components of the device 200.

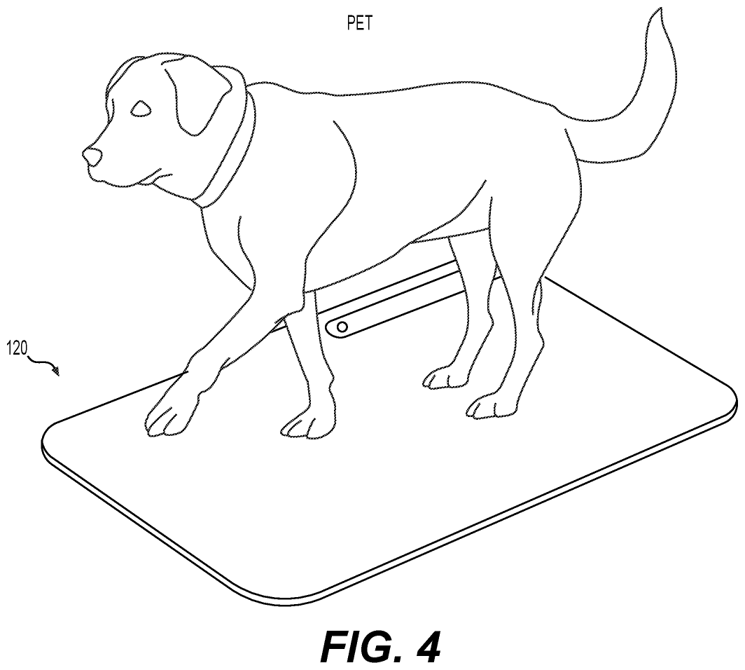

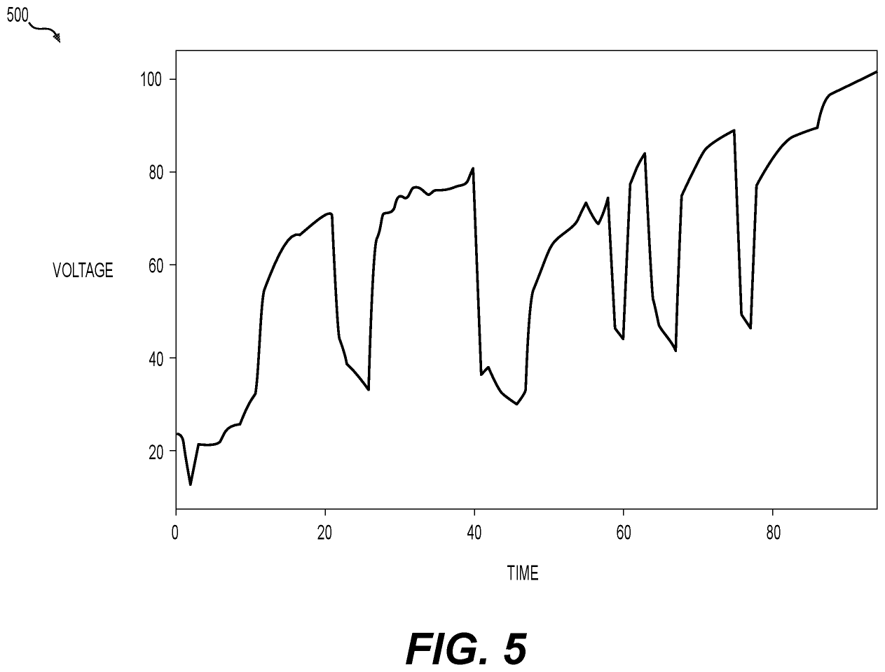

FIG. 3 is a diagram of an example mat 120 integrated with one or more pressure sensors 300 for generating sensor data, FIG. 4 is a diagram of a pet moving over the mat 120, and FIG. 5 is a diagram of example sensor data generated by the one or more pressure sensors 300 of the mat 120.

The mat 120 may include the one or more pressure sensors 300 for generating the sensor data. For example, the mat 120 may include one or more layers of material, and the one or more pressure sensors 300 may be provided in the one or more layers. The one or more pressure sensors 300 may be pressure sensors. For example, the one or more pressure sensors 300 may be piezoelectric sensors. As shown in FIG. 3, the one or more pressure sensors 300 may be grouped or arranged in a particular pattern, such as in a grid array. Although FIG. 3 depicts the mat 120 as including twenty pressure sensors 300, it should be understood that the one or more pressure sensors 300 may include any number n of pressure sensors.

The one or more pressure sensors 300 may be configured to generate sensor data based on a pet moving over the mat 120, as shown in FIG. 4. For example, as the pet moves over and/or stands on the mat 120, the pet may apply force and pressure to the mat 120, and the one or more pressure sensors 300 may generate sensor data based on the force and pressure being applied to the mat 120. As a particular example, the one or more pressure sensors 300 may generate voltage values over time based on the force and pressure applied to the mat 120 by the pet. As shown in FIG. 5, a plot 500 of the sensor data may include voltage values over time. The sensor data may include a voltage pattern that is represented by the voltages values over time.

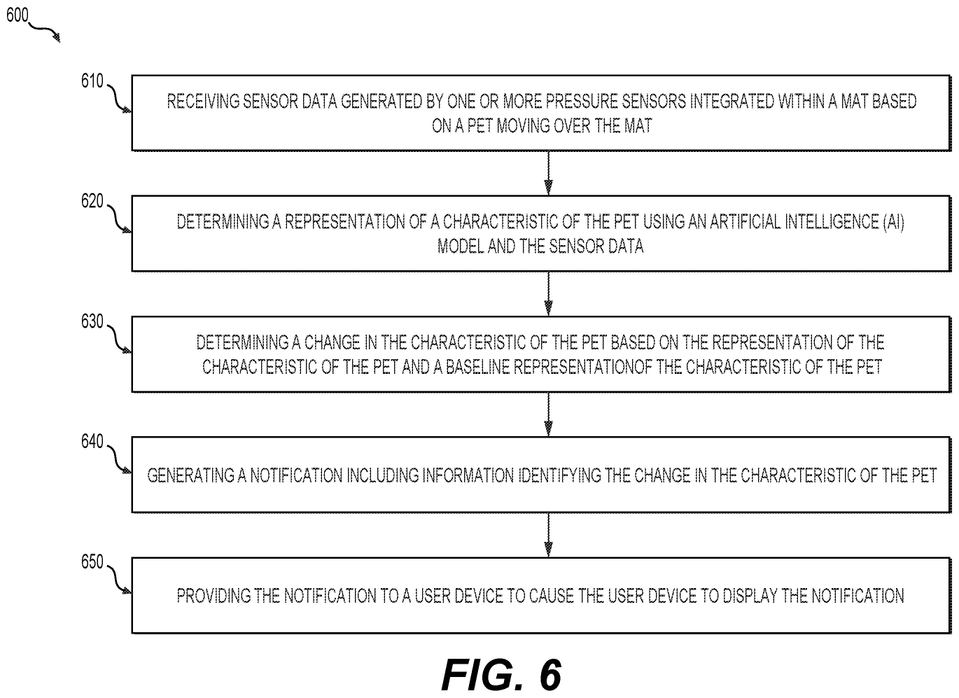

FIG. 6 is a flowchart depicting an example process 600 for determining a change in a characteristic of a pet.

As shown in FIG. 6, the process 600 may include receiving sensor data generated by one or more pressure sensors integrated within a mat based on the pet moving over the mat (operation 610).

For example, the platform 130 may obtain sensor data generated by the one or more pressure sensors 300 integrated within the mat 120 based on the pet moving over the mat 120. The platform 130 may obtain the sensor data directly from the mat 120 over the network 160 (e.g., via the microcontroller of the mat 120). Alternatively, the platform 130 may obtain the sensor data from the user device 110 or another intermediary device. In this case, the mat 120 may provide the sensor data to the user device 110 or the intermediary device, and the user device 110 or the intermediary device may forward the sensor data to the platform 130 over the network 160. The platform 130 may preprocess the sensor data using one or more preprocessing techniques, such as by performing data cleaning, data integration, data transformation, data standardization, data reduction, or the like. The platform 130 may obtain the sensor data based on a request, based on a predetermined time frame, based on an application of the user device 110 being executed, or the like.

The sensor data may include a voltage pattern represented by voltage values generated by the one or more pressure sensors 300 over time. For example, the sensor data may include a set of voltage values for a time frame. The set of voltage values defines a voltage pattern. The sensor data may include the voltage values, the timeframe, a timeframe indicator (e.g., timestamps), a pet identifier of the pet, a mat identifier of the mat 120, or the like.

As further shown in FIG. 6, the process 600 may include determining a representation of a characteristic of the pet using an artificial intelligence (AI) model and the sensor data (operation 620).

For example, the platform 130 may determine a representation of the characteristic of the pet using the AI model 140 and the sensor data. The characteristic of the pet may be any feature, quality, behavior, etc. of the pet. For example, the characteristic may be a weight of the pet (e.g., the value or amount that the pet weights). As another example, the characteristic may be a gait of the pet (e.g., the pet's manner of walking or moving). As a further example, the characteristic may be a behavioral pattern (e.g., the pet's energy level, the pet's fitness level, the pet's mood, etc.). The representation of the characteristic may refer to one or more values that represent the characteristic of the pet. For example, the representation of the characteristic for the weight of the pet may be a weight value. As another example, the representation of the characteristic for the gait of the pet may be a pattern of the sensor data indicative of gait. The platform 130 may provide the sensor data to the AI model 140 as an input, and determine the representation of the characteristic of the pet based on an output of the AI model 140.

The platform 130 may train the AI model 140 and store the AI model 140 for retrieval and use in performing operation 620. In other examples, the platform 130 may receive and store the AI model 140 trained by another system or device for retrieval and use in performing operation 620. For example, FIG. 7 is a flowchart depicting an example process 700 for training the AI model 140. As shown in FIG. 7, the process 700 may include receiving a plurality of training data sets (operation 710), training an AI model based on at least a portion of the plurality of training data sets (operation 720), and storing the AI model (operation 730).

In some examples, a trained AI model 140 common to a plurality of pets may be generated. In other examples, a separate, pet-specific trained AI model 140 may be generated for one or more of the plurality of pets (e.g., when sufficient training data is available for the pets).

Once trained, the AI model 140 may be stored in a database, and subsequently retrieved for execution by the platform 130 as part of the process flow for determining a change in a characteristic of a pet. For example, responsive to receiving sensor data, the AI model 140 may be deployed to determine a representation of a characteristic of a pet.

The AI model 140 may include a machine learning model configured to determine a representation of a characteristic of a pet. In some embodiments, the platform 130 may one or more of generate, store, train, or use the AI model 140. The platform 130 may include the AI model 140 and/or instructions associated with the AI model 140, e.g., instructions for generating the AI model 140, training the AI model 140, using the AI model 140, etc. In other embodiments, a system or device other than the platform 130 may be used to generate and/or train the AI model 140. For example, such a system may include instructions for generating the AI model 140 and the training data, and/or instructions for training the AI model 140. A resulting trained AI model 140 may then be provided to the platform 130 or user device 110 for use.

In the training phase, training data may be received and processed to generate (e.g., build) the AI model 140 for determining a representation of a characteristic of the pet. The training data may include a plurality of training datasets associated with a plurality of pets (e.g., the plurality of training datasets received at operation 710). An exemplary training dataset may include sensor data, a timeframe of the sensor data, and/or a known representation of a characteristic of a pet associated with the timeframe (e.g., a label) that may be provided as inputs to train the AI model 140.

The training data may be generated, received, or otherwise obtained from internal and/or external resources. For example, the training data may be retrieved from an external database and/or may be received directly from the mat 120.

Generally, the AI model 140 includes a set of variables, e.g., nodes, neurons, filters, etc., that are tuned, e.g., weighted or biased, to different values via the application of the training data. In some examples, the training process may employ supervised, unsupervised, semi-supervised, and/or reinforcement learning processes to train the AI model 140 (e.g., to result in the trained AI model 140) at the operation 720. In some embodiments, a portion of the training data may be withheld during training and/or used to validate the AI model 140.

When supervised learning processes are employed, labels or scores corresponding to the training data may facilitate the learning process by providing a ground truth. Training may proceed by feeding a training dataset (e.g., sensor data of the training dataset) into the AI model 140, the AI model 140 having variables set at initialized values, e.g., at random, based on Gaussian noise, a pre-trained model, or the like. The AI model 140 may output a representation of a characteristic of a pet. The output may be compared with the corresponding label or score (e.g., the ground truth) indicating the known representation of the characteristic of the pet, which may then be back-propagated through the model to adjust the values of the variables. For example, for the characteristic of weight, a weight value predicted by the AI model 140 based on the sensor data may be compared to a known weight value of the pet at the time the sensor data of the training dataset was generated. As another example, for the characteristic of gait, the pattern indicative of gait predicted by the AI model 140 based on the sensor data may be compared to a pattern known to be reflective of the pet's gait at the time the sensor data of the training dataset was generated. This process may be repeated for at least the portion of the training datasets at least until a determined loss or error is below a predefined threshold. In some examples, some of the training data may be withheld and used to further validate or test the trained AI model 140.

For an unsupervised learning process, the training data may not include pre-assigned labels or scores to aid the learning process. Rather, an unsupervised learning processes may include clustering, classification, or the like, to identify naturally occurring patterns in the training data. As one example, characteristics may be clustered into groups based on identified similarities and/or patterns. K-means clustering or K-Nearest Neighbors may also be used, which may be supervised or unsupervised. Combinations of K-Nearest Neighbors and an unsupervised cluster technique may also be used. For semi-supervised learning, a combination of training data with pre-assigned labels or scores and training data without pre-assigned labels or scores may be used to train the AI model 140.

When reinforcement learning is employed, an agent (e.g., an algorithm) may be trained to make a decision regarding the representation of the characteristic of the pet through trial and error. For example, upon making a decision, the agent may then receive feedback (e.g., a positive reward if the predicted characteristic of the pet was accurate), adjust its next decision to maximize the reward, and repeat until a loss function is optimized.

Returning to FIG. 6, the process 600 may include determining a change in the characteristic of the pet based on the representation of the characteristic of the pet and a baseline representation of the characteristic of the pet (operation 630).

In some implementations, the platform 130 may determine the change in the characteristic of the pet based on comparing the representation of the characteristic of the pet and a baseline representation of the characteristic of the pet.

The baseline representation of the characteristic of the pet may be a baseline from which a change in a characteristic of the pet can be determined. For example, the baseline representation of the characteristic of the pet may be the immediately preceding determined representation of the characteristic of the pet by the AI model 140, may be an average of previously determined representations of the characteristic of the pet by the AI model 140, may be the first previously determined representation of the characteristic of the pet by the AI model 140, and/or may be based on information provided by the pet owner (e.g., a weight value of the pet self-reported by the pet owner).

In some implementations, the platform 130 may identify a particular baseline representation of the characteristic of the pet to which to compare the representation of the characteristic of the pet. For example, the platform 130 may store a set of baseline representations of the characteristic of the pet (e.g., in one of the data storage systems of and/or associated with the platform 130), and identify a particular baseline representation of the characteristic of the pet from the set of stored baseline representations of the characteristic of the pet.

In some implementations, the platform 130 may determine a timeframe (e.g., time of day, day of the week, etc.) of the representation of the characteristic of the pet, and identify a baseline representation of the characteristic of the pet that corresponds to the timeframe. For example, the platform 130 may determine a timeframe that is correlated with the sensor data that was used to determine the representation of the characteristic of the pet, and determine the timeframe of the representation of the characteristic of the pet based on the timeframe being correlated with the sensor data. In this way, the platform 130 may more accurately determine a change in a characteristic of the pet by comparing the representation of the characteristic of the pet with a baseline representation of the characteristic of the pet that more closely corresponds to the timeframe at which the sensor data, that was used to determine the representation of the characteristic of the pet, was obtained.

In some implementations, the platform 130 may identify the particular pet based on the representation of the characteristic of the pet, and determine a baseline representation of the characteristic corresponding to the particular pet. For instance, the pet owner may have multiple pets. In this case, the multiple pets and the owner may move over the mat 120 throughout the course of the day. The platform 130 may determine the particular pet by comparing the representation of the characteristic of the pet with baseline representations of the characteristics of the multiple pets. In this case, the platform 130 may select a baseline representation of the characteristic of a particular pet that most closely matches the representation of the characteristic of the pet, and use the selected representation of the characteristic of the pet when determining the change in the characteristic of the pet. In some implementations, the platform 130 may determine that the representation of the characteristic corresponds to the pet owner, and prevent further processing.

As further shown in FIG. 6, the process 600 may include generating a notification including information identifying the change in the characteristic of the pet (operation 640), and providing the notification to a user device to cause the user device to display the notification (operation 650).

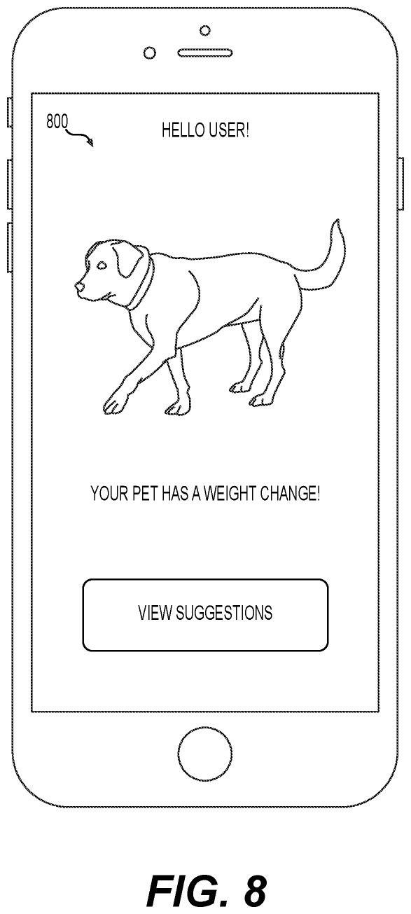

For example, the platform 130 may provide, to the user device 110, information identifying the change in the characteristic of the pet to permit the user device 110 to display the information identifying the change in the characteristic of the pet. FIG. 8 is a diagram of an example user interface 800 of the user device 110 for displaying information identifying the change in the characteristic of the pet determined by the platform 130. For example, as shown in FIG. 8, the user device 110 may display information identifying the change in the characteristic (e.g., weight) of the pet. The user device 110 may also display an icon (“view suggestions”) that permits the owner to obtain additional information, such as suggestions or recommendations, regarding the change in the characteristic of the pet.

Returning to operations 640 and 650 of the process 600 of FIG. 6, in some implementations, the platform 130 may generate and provide the notification including the information identifying the change in the characteristic of the pet, based on the change in characteristic of the pet satisfying a threshold. For example, the platform 130 may compare the representation of the characteristic of the pet with the baseline representation of the characteristic of the pet, and determine that a difference between the representation of the characteristic of the pet and the baseline representation of the characteristic of the pet satisfies a threshold. For instance, when the characteristic is weight, the difference between the weight value output by the AI model 140 and the baseline weight value of the pet might indicate that the pet has gained a threshold amount of weight, or that the pet has lost a threshold amount of weight. As another example, when the characteristic is gait, the difference between the gait pattern output by the AI model 140 and the baseline gait pattern of the pet might indicate that the pet is limping, is not fully utilizing a particular limb, or the like.

In some implementations, when the characteristic is weight, the information identifying the change in the characteristic of the pet may include a weight value of the pet output by the AI model 140 (e.g., 10 pounds), may include a weight change of the pet (e.g., +1 pound, −2 pounds, etc.), may include a target weight of the pet (e.g., 9 pounds), or the like. Alternatively, the information identifying the change in the characteristic of the pet may identify that the pet has a weight change, and might not include a particular weight value or a particular change in weight. In some implementations, when the characteristic is gait, the information identifying the change in the gait of the pet may identify that the pet has a gait change, and/or an indication that the gait change is indicative of a mobility issue and/or injury.

In some implementations, the information identifying the change in the characteristic of the pet (e.g., the change in the weight and/or gait) of the pet may include information that provides a recommendation or suggestion to the pet owner. For example, the information may include an instruction for the pet owner to seek medical attention, to schedule an appointment, to adjust behavior of the pet, to adjust care of the pet, or the like.

In some implementations, the platform 130 may obtain external data from various external data sources, including the sensor device 150, for example, and input the information identifying the change in the characteristic of the pet and the external data into an AI model (which may be the same AI model or a different AI model than the AI model 140 described above). The platform 130 may determine information associated with the characteristic of the pet for provision as the recommendation or suggestion based on an output of the AI model. The external data may include additional data of the pet and/or environmental data. For example, the platform 130 may obtain activity information of the pet, feeding information of the pet, vital information of the pet, blood information of the pet, stool information of the pet, weather information, sound information of the pet, temperature information of the pet, sleeping information of the pet, or the like.

In some implementations, feedback associated with the output of the AI model 140 may be received and used to update the AI model 140. The feedback may indicate whether or not the representation of the characteristic of the pet determined by the AI model at operation 620 was correct. In some examples, the feedback may be received from the user device 110 responsive to providing the notification. To provide an illustrative example, for a characteristic of weight, a weight value output by the AI model 140 may be 90 pounds which is included in the notification information, and the user may confirm (e.g., based on a recent vet visit) that their pet is about 90 pounds. The feedback may be used as a label to create a new training dataset for use in retraining the AI model 140. Resultantly, one or more aspects of the AI model 140, such as the weights and/or bias, may be further modified or tuned for improved accuracy. In some examples, the AI model 140 may be retrained after a predefined number of new training datasets have been received.

Although the implementations herein are described in connection with a pet, it should be understood that the implementations are applicable to any other type of mobile object, such as a human, an animal, etc. Moreover, although implementations herein are described in connection with a pet, it should be understood that the implementations herein are applicable to animals that are not pets, such as livestock, zoo animals, undomesticated animals, etc.

In this way, the embodiments herein provide techniques for quickly, practically, easily, frequently, and accurately monitoring for and determining a change in pet characteristics, such as a change in a weight and/or a change in a gait of a pet. Moreover, the embodiments herein provide techniques for monitoring for and determining a change in pet characteristics, such as a change in a weight and/or a change in a gait that requires less dedicated hardware and that is less intrusive than other techniques.

While principles of the present disclosure are described herein with reference to illustrative embodiments for particular applications, it should be understood that the disclosure is not limited thereto. Those having ordinary skill in the art and access to the teachings provided herein will recognize additional modifications, applications, embodiments, and substitution of equivalents all fall within the scope of the embodiments described herein. Accordingly, the present disclosure is not to be considered as limited by the foregoing description.

We claim:

1. A method for determining a change in a characteristic of a pet, the method comprising:
receiving, by one or more processors, sensor data generated by one or more pressure sensors integrated within a mat based on the pet moving over the mat;
determining, by the one or more processors, a representation of the characteristic of the pet using an artificial intelligence (AI) model and the sensor data;
determining, by the one or more processors, the change in the characteristic of the pet based on the representation of the characteristic of the pet and a baseline representation of the characteristic of the pet;
generating, by the one or more processors, a notification including information identifying the change in the characteristic of the pet; and
providing, by the one or more processors, the notification to a user device to cause the user device to display the notification.

2. The method of claim 1, wherein the characteristic is a weight of the pet, and the representation of the characteristic is a weight value of the pet.

3. The method of claim 1, wherein the characteristic is a gait of the pet, and the representation of the characteristic is a pattern indicative of gait.

4. The method of claim 1, further comprising:
determining that the change in the characteristic of the pet satisfies a threshold,
wherein the generating the notification comprises generating the notification based on determining that the change in the characteristic of the pet satisfies the threshold.

5. The method of claim 1, wherein the characteristic is a weight of the pet, and the change in the characteristic of the pet is indicative of the pet having gained a threshold amount of weight or having lost the threshold amount of weight.

6. The method of claim 1, wherein the one or more pressure sensors comprise piezoelectric sensors.

7. The method of claim 1, wherein the sensor data includes a voltage pattern represented by voltage values over time.

8. A device for determining a change in a characteristic of a pet, the device comprising:
a memory configured to store instructions; and
one or more processors configured to execute the instructions to perform operations comprising:
receiving sensor data generated by one or more pressure sensors integrated within a mat based on the pet moving over the mat;
determining a representation of the characteristic of the pet using an artificial intelligence (AI) model and the sensor data;
determining the change in the characteristic of the pet based on the representation of the characteristic of the pet and a baseline representation of the characteristic of the pet;
generating a notification including information identifying the change in the characteristic of the pet; and
providing the notification to a user device to cause the user device to display the notification.

9. The device of claim 8, wherein the characteristic is a weight of the pet, and the representation of the characteristic is a weight value of the pet.

10. The device of claim 8, wherein the characteristic is a gait of the pet, and the representation of the characteristic is a pattern indicative of gait.

11. The device of claim 8, wherein the operations further comprise:
determining that the change in the characteristic of the pet satisfies a threshold,
wherein the generating the notification comprises generating the notification based on determining that the change in the characteristic of the pet satisfies the threshold.

12. The device of claim 8, wherein the characteristic is a weight of the pet, and the change in the characteristic of the pet is indicative of the pet having gained a threshold amount of weight or having lost the threshold amount of weight.

13. The device of claim 8, wherein the one or more pressure sensors comprise piezoelectric sensors.

14. The device of claim 8, wherein the sensor data includes a voltage pattern represented by voltage values over time.

15. A non-transitory computer-readable medium configured to store instructions that, when executed by one or more processors of a device for determining a change in a characteristic of a pet, cause the one or more processors to perform operations comprising:
receiving sensor data generated by one or more pressure sensors integrated within a mat based on the pet moving over the mat;
determining a representation of the characteristic of the pet using an artificial intelligence (AI) model and the sensor data;
determining the change in the characteristic of the pet based on the representation of the characteristic of the pet and a baseline representation of the characteristic of the pet;
generating a notification including information identifying the change in the characteristic of the pet; and
providing the notification to a user device to cause the user device to display the notification.

16. The non-transitory computer-readable medium of claim 15, wherein the characteristic is a weight of the pet, and the representation of the characteristic is a weight value of the pet.

17. The non-transitory computer-readable medium of claim 15, wherein the characteristic is a gait of the pet, and the representation of the characteristic is a pattern indicative of gait.

18. The non-transitory computer-readable medium of claim 15, wherein the operations further comprise:
determining that the change in the characteristic of the pet satisfies a threshold,
wherein the generating the notification comprises generating the notification based on determining that the change in the characteristic of the pet satisfies the threshold.

19. The non-transitory computer-readable medium of claim 15, wherein the characteristic is a weight of the pet, and the change in the characteristic of the pet is indicative of the pet having gained a threshold amount of weight or having lost the threshold amount of weight.

20. The non-transitory computer-readable medium of claim 15, wherein the one or more pressure sensors comprise piezoelectric sensors, and wherein the sensor data includes a voltage pattern represented by voltage values over time.
